(19) United States
(12) Patent Application Publication
(10) Pub. No.: US 2016/0300531 A1
(43) Pub. Date: Oct. 13, 2016

(54) PIXEL CIRCUIT AND DISPLAY APPARATUS

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Shengji YANG, Beijing (CN); Xue DONG, Beijing (CN); Haisheng WANG, Beijing (CN)

(21) Appl. No.: 14/443,534

(22) PCT Filed: Sep. 5, 2014
(86) PCT No.: PCT/CN2014/086048

§ 371 Date: May 18, 2015

(30) Foreign Application Priority Data
Jun. 18, 2014 (CN) 201410274190.6

(51) Int. Cl. G09G 3/3258; G09G 3/3291

(52) U.S. Cl. CPC G09G 3/3258; G09G 3/3291; G09G 2300/043; G09G 2300/0426; G09G 2320/043; G09G 2320/045; G09G 2320/0233; G09G 2300/0809

(57) ABSTRACT

Provided is a pixel circuit comprising two sub-pixel circuits(P1, P2) of the same structure. Each sub-pixel circuit(P1, P2) comprises five switch units(T1, T2, T3, T4, T5), a driving unit(DT), an energy storage unit(C) and an electroluminescent unit(L). The two sub-pixel circuits (P1, P2) are connected to the same operating voltage line(Vdd), the same data voltage line(Vdata), the same first scanning signal line(Scan[1]), and the same third scanning signal line(Scan[3]), and are connected to different second scanning signal lines(Scan[2]), so that in the pixel circuit, the operating current flowing through the electroluminescent unit(L) is not affected by the threshold voltage of the corresponding driving transistor, completely solving the problem of non-uniformity in the display brightness due to drifting of the threshold voltage of the driving transistor. Meanwhile, a compensation circuit is used to drive two pixels(P1, P2), and two adjacent pixels(P1, P2) share a plurality of signal lines, thus reducing the number of signal lines for the pixel circuits in a display apparatus, decreasing the pixel pitch, and increasing the pixel density. Also provided is a display apparatus using the pixel circuit.

### TECHNICAL FIELD OF THE DISCLOSURE

The present disclosure relates to a pixel circuit and display apparatus.

### BACKGROUND

Nowadays, organic light emitting displays (OLED) have become one of the hotspots in the study field of flat panel displays. Compared with liquid crystal displays, OLED has the advantages of low power consumption, low production cost, self light emitting, wide viewing angle and fast response and so on. Currently, OLED has begun to replace the traditional liquid crystal displays (LCD) in the display areas such as mobile-phones, PDAs and digital cameras. Pixel driving circuit design is the core technical content of OLED displays and has important meaning for the study.

OLED is current-driven and needs a stable current to control light emission, which is different from the TFT (Thin Film Transistor)—LCD that uses a stable voltage to control brightness.

Due to process technology, device aging and other reasons, in the original 2T1C driving circuit (comprising two thin film transistors and one capacitor), the threshold voltages of driving TFTs at each pixel are not uniform, which causes changes in the current flowing through the OLED at each pixel so that the display brightness are not uniform, thus affecting the display effect of the entire image.

In the known technology, one pixel circuit generally corresponds to one pixel. Each pixel circuit comprises at least one data voltage line, one operating voltage line and a plurality of scanning signal lines, which causes the corresponding production process more complicated, and not conducive to reducing the pixel pitch.

### SUMMARY

The present disclosure can solve the problem of non-uniformity in the display brightness of a display apparatus, and reduce the number of signal lines for pixel circuits in the display apparatus as well as the IC costs, while increasing the pixel density of the display apparatus.

According to one aspect of the present disclosure, there is provided a pixel circuit comprising two sub-pixel circuits; each sub-pixel circuit comprises a first switch unit, a second switch unit, a third switch element, a fourth switch unit, a fifth switch unit, a driving unit, an energy storage unit, and an electroluminescent unit; a first terminal of the first switch unit is connected to an operating voltage line, a second terminal of the first switch unit is connected to an input of the driving unit, and the first switch unit is configured to provide an operating voltage to the driving unit under the control of a scanning signal line connected to a control terminal of the first switch unit; a first terminal of the second switch unit is connected to an output of the driving unit, a second terminal of the second switch unit is connected to the electroluminescent element, and the second switch unit is configured to introduce a driving current provided by the driving unit into the electroluminescent element under the control of a scanning signal line connected to a control terminal of the second switch unit; a first terminal of the third switch unit is connected to a data voltage line, a second terminal of the third switch unit is connected to the input of the driving unit, and the third switch unit is configured to connect the input of the driving unit to the data voltage line under the control of a scanning signal line connected to a control terminal of the third switch unit; a first terminal of the fourth switch unit is connected to the output of the driving unit, a second terminal of the fourth switch unit is connected to a first terminal of the energy storage unit and a control terminal of the driving unit, and the fourth switch unit is configured to make the output terminal of the driving unit and the control terminal of the driving unit conductive and charge the first terminal of the energy storage unit with the voltage at the output of the driving unit under the control of a scanning signal line connected to a control terminal of the fourth switch unit; a first terminal of the fifth switch unit is connected to the first terminal of the energy storage unit, a second terminal of the fifth switch unit is grounded, and the fifth switch unit is configured to set the voltage at the first terminal of the energy storage unit to zero under the control of a scanning signal line connected to a control terminal of the fifth switch unit; and in the two sub-pixel circuits, the first terminals of the third switch units are connected to the same data voltage line, the control terminals of the first switch units and the second switch units are all connected to a third scanning signal line, the control terminals of the fifth switch units are connected to a fourth scanning signal line; the control terminals of the third switch unit and the fourth switch unit in the first sub-pixel circuit are both connected to a first scanning signal line; and the control terminals of the third switch unit and the fourth switch unit in the second sub-pixel circuit are both connected to a second scanning signal line.

In some embodiments, each of the switch units and each of the driving units are thin film transistors. The control terminal of each switch unit is a gate of the thin film transistor, the first terminal of each switch unit is a source of the thin film transistor, and the second terminal of each switch unit is a drain of the thin film transistor. The control terminal of each driving unit is a gate of the thin film transistor, the input of each driving unit is a source of the thin film transistor, and the output of each driving unit is a drain of the thin film transistor.

In some embodiments, each of the thin film transistors is of P-channel type.

In some embodiments, the energy storage unit is a capacitor.

In some embodiments, the electroluminescent unit is an organic light emitting diode.

The present disclosure also provides a display apparatus characterized in that it comprises the pixel circuit according to any one of the foregoing.

In some embodiments, the two sub-pixel circuits are positioned within two adjacent pixels respectively.

In some embodiments, the two adjacent pixels are positioned on both sides of the data voltage line respectively.

In some embodiments, the two adjacent pixels are positioned on the same side of the data voltage line.

In the pixel circuit provided by the present disclosure, the operating current flowing through the electroluminescent unit is not affected by the threshold voltage of the corresponding driving transistor, which completely solves the problem of non-uniformity in the display brightness due to drifting of the threshold voltage of the driving transistor. Meanwhile, in the present disclosure, one compensation circuit is used to drive two pixels, and two adjacent pixels share a plurality of signal lines, which can reduce the number of signal lines for pixel circuits in a display apparatus as well as the IC costs, decrease the pixel pitch, and increase the pixel density.

### BRIEF DESCRIPTION OF THE DRAWINGS

FIG. 1 is a schematic structural diagram of a pixel circuit provided by an embodiment of the present disclosure;

FIG. 2 is a time sequence diagram of key signals in the pixel circuit provided by the embodiment of the present disclosure;

FIGS. 3 (a)-3 (d) are schematic diagrams of current flow directions and voltage values of the pixel circuit in the embodiment of the present disclosure at different timings;

FIG. 4 is a schematic diagram of a positional relationship between pixel circuits and pixels in a display apparatus provided by an embodiment of the present disclosure;

FIG. 5 is a schematic diagram of another positional relationship between pixel circuits and pixels in a display apparatus provided by an embodiment of the present disclosure.

### DETAILED DESCRIPTION

In the following, implementations of the present disclosure are further described in connection with figures and embodiments. The following embodiments are only for illustrating the technical solutions of the present disclosure more clearly, but not for limiting the protection scope of the present disclosure.

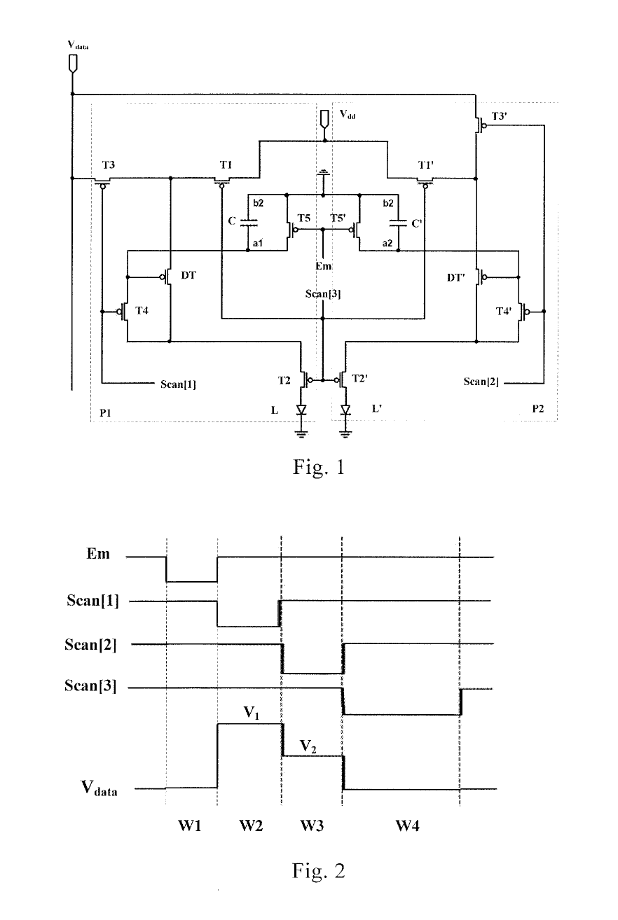

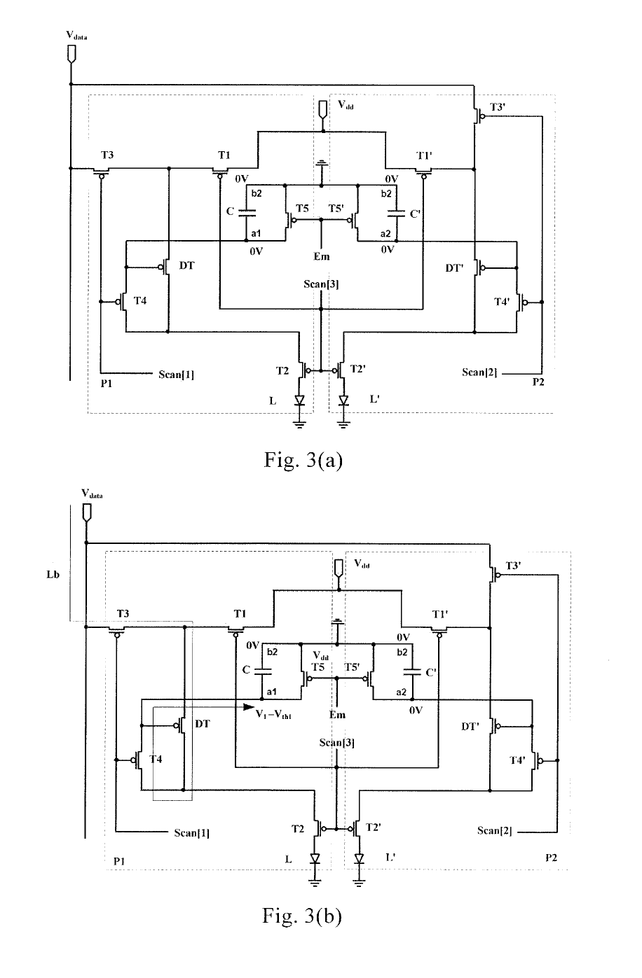

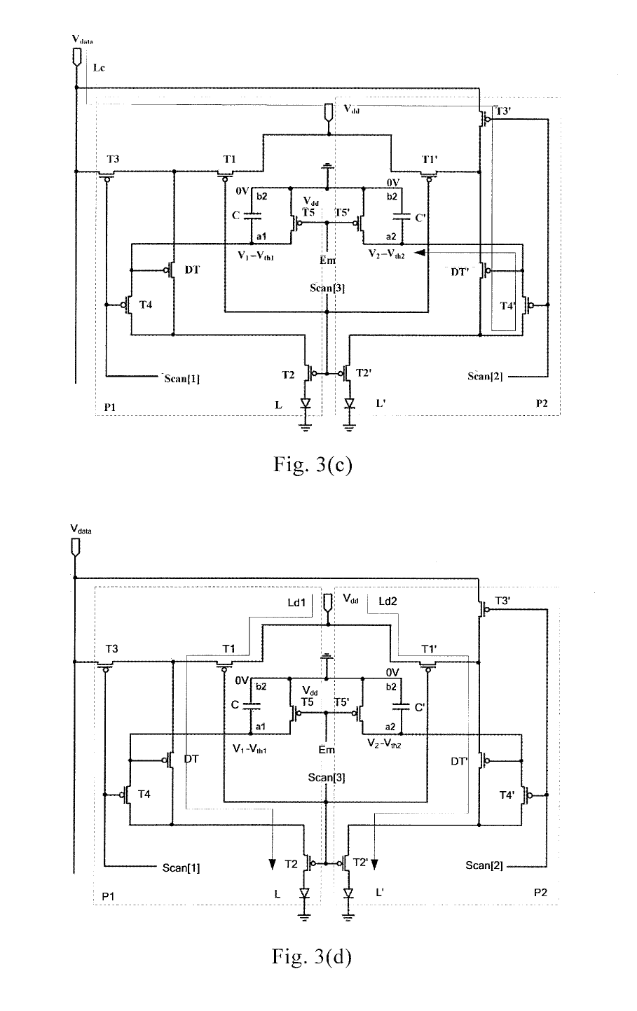

An embodiment of the present disclosure provides a pixel circuit. As shown in FIG. 1 or FIGS. 3(a)-3(d), the pixel circuit comprises two sub-pixel circuits P1 and P2 of the same structure, and each of the sub-pixel circuit corresponds to one pixel. As P1 and P2 are of the same structure, in the following, descriptions on the two sub-pixel circuits will be made only in connection with the structure of Pl.

P1 herein comprises five switch units T1, T2, T3, T4 and T5, one driving unit DT, one energy storage unit C and one electroluminescent unit L (in order to facilitate the distinction, in FIG. 1 or FIG. 3, for P2, the five switch units are represented as T1′, T2′, T3′, T4′ and T5′ respectively, the driving unit is represented as DT′, the energy storage unit is represented as C′ and the electroluminescent unit is represented as same below). In addition, control terminals of T1 and T2 are both connected to a third scanning signal line Scan[3]. A first terminal of T1 is connected to an operating voltage line Vdd, a second terminal of T1 is connected to an input of DT, and T1 is configured to provide an operating voltage to the driving unit DT under the control of the scanning signal line connected to the control terminal of T1; a first terminal of T2 is connected to an output of DT, a second terminal of T2 is connected to L, and T2 is configured to introduce a driving current provided by the driving unit DT into the electroluminescent element L under the control of a scanning signal line connected to the control terminal of T2; a first terminal of T3 is connected to a data voltage line Vdata, a second terminal of T3 is connected to the input of DT, and T3 is configured to connect the input of the driving unit to the data voltage line Vdata under the control of the scanning signal line connected to the control terminal of T3; a first terminal of T4 is connected to the output of DT, a second terminal of T4 is connected to a first terminal a1 of C and a control terminal of DT (for C′, its first terminal is a2 and second terminal is b2), and T4 is configured to make the output terminal of the driving unit DT and the control terminal of the driving unit DT conductive and charge the first terminal of the energy storage unit C with the voltage at the output of the driving unit DT under the control of the scanning signal line connected to the control terminal of T4; a first terminal of T5 is connected to terminal a1 of C, a second terminal of T5 is connected to a second terminal b1 of C, and T5 is configured to set the voltage at the first terminal of the energy storage unit C to zero under the control of the scanning signal line connected to the control terminal of T5; and in the two sub-pixel circuits, the first terminals of T3 and T3′ are connected to the same data voltage line Vdata, the control terminals of the first switch units and the second switch units are all connected to a third scanning signal line Scan[3], the control terminals of the fifth switch units are connected to a fourth scanning signal line Em; the control terminals of the third switch unit and the fourth switch unit in the first sub-pixel circuit are both connected to a first scanning signal line Scan[1]; and the control terminals of the third switch unit and the fourth switch unit in the second sub-pixel circuit are both connected to a second scanning signal line Scan [2].

It will be appreciated that two switch units whose control terminals are connected to the same scanning signal line (such as T1 and T1′, T3 and T4, T3′ and T4′, T5 and T5′) should be switches of the same channel type, i.e., both turned on by a high voltage level or both turned on by a low voltage level, thus ensuring the turn-on or turn-off states of the two switch units connected to the same scanning signal line are identical.

In the pixel circuit provided by the embodiment of the present disclosure, the operating current flowing through the electroluminescent unit is not affected by the threshold voltage of the corresponding driving transistor, which completely solves the problem of non-uniformity in the display brightness due to drifting of the threshold voltage of the driving transistor. Meanwhile, in the embodiment of the present disclosure, one compensation circuit is used to drive two pixels, and two adjacent pixels share a plurality of signal lines, which can reduce the number of signal lines for pixel circuits in a display apparatus as well as the IC costs, decrease the pixel pitch, and increase the pixel density.

In some embodiments, each of the switch units and each of the driving units are thin film transistors. The control terminal of each switch unit is a gate of the thin film transistor, the first terminal of each switch unit is a source of the thin film transistor, and the second terminal of each switch unit is a drain of the thin film transistor. The control terminal of each driving unit is a gate of the thin film transistor, the input of each driving unit is a source of the thin film transistor, and the output of each driving unit is a drain of the thin film transistor.

Understandably, the transistors herein corresponding to the driving units and the switch units may be transistors whose source and drain are interchangeable, or depending on the type of conduction, the first terminals of each switch unit and each driving unit may be drains of the transistors and the second terminals thereof may be sources. Circuit structures made by the skilled in the art without creative work, which are obtained by reversing the sources and drains of respective transistors in the pixel circuit provided by the present disclosure and which can achieve the same or similar technical effects as the technical solutions provided by the present disclosure, should fall within the protection scope of the present disclosure.

Further, in the embodiments of the present disclosure, each of the thin film transistors is of P-channel type. By using the same type of transistors, it is possible to unify production process, thereby improving the product yield. The skilled in the art will understand that, in practice, the types of respective transistors may not be identical. For example, T1 may be a N-channel transistor, while T2 may be a P-channel transistor. As long as the turn-on/turn-off states of the two switch units whose control terminals are connected to the same scanning signal line are identical, the technical solution provided by the present application can be realized. The exemplary embodiments of the present disclosure should not be construed as limiting the protection scope of the present disclosure.

In some embodiments, the energy storage unit C is a capacitor. Of course, in practice, other elements with energy storage function can also be adopted according to the design requirements.

In some embodiments, the electroluminescent unit L can be an organic light emitting diode (OLED). Of course, other elements with electroluminescent function can also be adopted according to the design requirements.

Referring to FIGS. 2 and 3, the work principle of the pixel circuit provided by an exemplary embodiment of the present disclosure will now be described in details. FIG. 2 shows a time sequence diagram of scanning signals input into respective scanning signal lines when the pixel circuit provided by the present disclosure is working. The time sequence diagram can be divided into four stages, which are shown in FIG. 2 respectively as a reset stage W1, a first charging stage W2, a second charging stage W3 and a light emitting stage W4. In each stage, the current flow directions and voltage values of the pixel circuit are shown in FIG. 3 (a), FIG. 3(b), FIG. 3(c) and FIG. 3 (d) respectively. To facilitate explanation, further descriptions will be made given that the respective switch units and driving units are TFTs of P-channel type and the second terminals b1 and b2 of the two capacitors are grounded.

In the reset stage WI, as shown in FIG. 2, among the scanning signal lines, only Em is at low voltage level, and the other scanning signal lines are at high voltage levels. At this time, only T5 and T5′ are turned on, and the other TFTs are turned off. As shown in FIG. 3 (a), at this point, both terminals of capacitor C and both terminals of capacitor C′ are grounded, and potentials at points a1, a2, b1, b2 are all zero.

In the first charging stage W2, as shown in FIG. 2, among the scanning signal lines, only Scan[1] is at low voltage level, and the other scanning signal lines are at high voltage levels. The data voltage V_{data}=V1, and V1 is a voltage corresponding to the organic light emitting diode L. At this time, only T3, T4 and DT are turned on, the other switch TFTs are turned off, and the current charges the energy storage unit C in P1 along Lb in FIG. 3(b). After the charging is completed, the potential at point a1 equals to V1−Vₜₕ₁ (satisfying that the voltage difference between the gate and source of DT is Vₜₕ₁, wherein Vth1 is the threshold voltage of DT).

In the second charging stage W3, as shown in FIG. 2, among the scanning signal lines, only Scan[2] is at low voltage level, and the other scanning signal lines are at high voltage levels. Data voltage V_{data}=V2, wherein V2 is the voltage corresponding to organic light emitting diode L′. At this time, only T3′, T4′ and DT′ are turned on, the other switch TFTs are turned off, and the current charges the energy storage unit C′ in P2 along Le in FIG. 3 (c). After the charging is completed, the potential at point a2 equals to V2−Vₜₕ₂ (satisfying that the voltage difference between the gate and source of DT′ is Vₜₕ₂, wherein Vth2 is the threshold voltage of DT′).

In the light emitting stage W4, as shown in FIG. 2, among the scanning signal lines, only Scan[3] is at low voltage level, and the other scanning signal lines are at high voltage levels. At this time, T1, T2, T1′, T2′, DT and DT′ are turned on, the other TFTs are turned off, Vdd supplies current to L and L′ respectively along Ld1 and Ld2 in FIG. 3(d), making L and L′ emit light.

According to the saturation current formula, at this point the current flowing through L is I_{L}=K (V_{GS}−Vₜₕ₁)²=[V_{dd}−(V₁−Vₜₕ₁)−Vₜₕ₁]²=K(V_{dd}−V₁)².

Similarly, I_{L′}=K(V_{dd}−V2)². As can be seen from the above formula, at this time, the operating current flowing through the two electroluminescent units is not affected by the threshold voltages of the driving transistors, and is only related to the data voltage V_{data}. The problem of threshold voltage(Vₜₕ) drift of the driving TFT due to the process technology and the long-time operation is completely solved, thus eliminating its influence on the current flowing through the electroluminescent unit, and ensuring the normal operation of the electroluminescent unit.

Based on the same concept, the present disclosure also provides a display apparatus comprising the pixel circuit of any one of the foregoing. The display apparatus can be any products or means with a display function, such as electronic paper, mobile phones, tablets, televisions, displays, notebook computers, digital photo frames and navigators, etc.

In some embodiments, in the display apparatus, the two sub-pixel circuits of the pixel circuit are positioned within two adjacent pixels respectively. In this way, components and parts can be distributed more uniformly on the respective substrates.

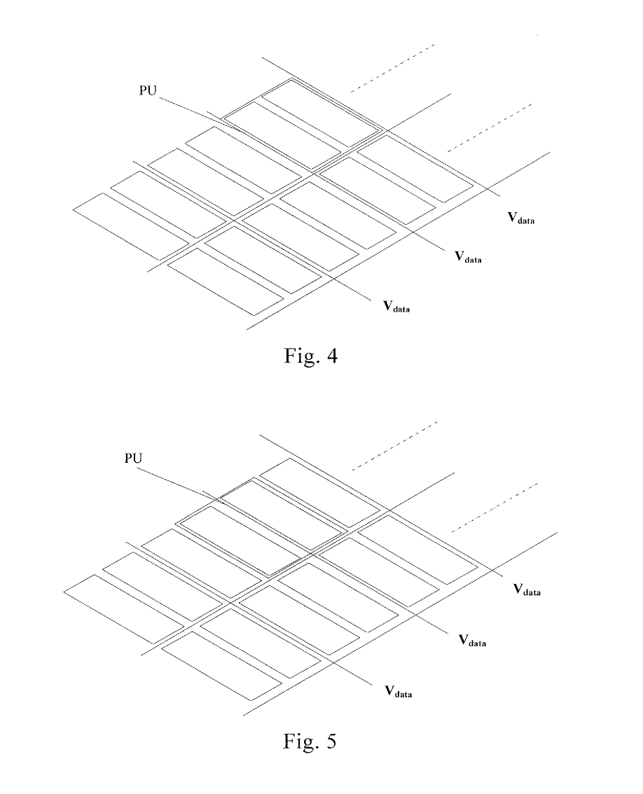

In some embodiments, the two adjacent pixels are positioned on the same side of their data voltage line. FIG. 4 shows a case in which two adjacent pixels corresponding to one pixel circuit PU are at one side of the their corresponding data voltage line V_{data}. Alternatively, the two adjacent pixels are positioned on both sides of their data voltage line respectively. FIG. 5 shows a case in which two adjacent pixels corresponding to one pixel circuit PU are at both sides of the their corresponding data voltage line V_{data}.

The above descriptions are only preferred implementations of the present disclosure. It should be noted that an ordinary skilled person in the art can also make a number of improvements and modifications without departing from the technical principle of the present disclosure, and these improvements and modifications should also be considered as within the protection scope of the present disclosure.

The present application claims the priority of Chinese Patent Application No. 201410274190.6 filed on Jun. 18, 2014, entire content of which is incorporated as part of the present application by reference.

1. A pixel circuit comprising two sub-pixel circuits, wherein
each sub-pixel circuit comprises a first switch unit, a second switch unit, a third switch element, a fourth switch unit, a fifth switch unit, a driving unit, an energy storage unit and an electroluminescent element; and
a first terminal of the first switch unit is connected to an operating voltage line, a second terminal of the first switch unit is connected to an input of the driving unit, and the first switch unit is configured to provide an operating voltage to the driving unit under the control of a scanning signal line connected to a control terminal of the first switch unit;
a first terminal of the second switch unit is connected to an output of the driving unit, a second terminal of the second switch unit is connected to the electroluminescent element, and the second switch unit is configured to introduce a driving current provided by the driving unit into the electroluminescent element under the control of a scanning signal line connected to a control terminal of the second switch unit;
a first terminal of the third switch unit is connected to a data voltage line, a second terminal of the third switch unit is connected to the input of the driving unit, and the third switch unit is configured to connect the input of the driving unit to the data voltage line under the control of a scanning signal line connected to a control terminal of the third switch unit;
a first terminal of the fourth switch unit is connected to the output of the driving unit, a second terminal of the fourth switch unit is connected to a first terminal of the energy storage unit and a control terminal of the driving unit, and the fourth switch unit is configured to make the output terminal of the driving unit and the control terminal of the driving unit conductive and charge the first terminal of the energy storage unit with the voltage at the output of the driving unit under the control of a scanning signal line connected to a control terminal of the fourth switch unit;
a first terminal of the fifth switch unit is connected to the first terminal of the energy storage unit, a second terminal of the fifth switch unit is grounded, and the fifth switch unit is configured to set the voltage at the first terminal of the energy storage unit to zero under the control of a scanning signal line connected to a control terminal of the fifth switch unit; and
in the two sub-pixel circuits, the first terminals of the third switch units are connected to the same data voltage line, the control terminals of the first switch units and the second switch units are all connected to a third scanning signal line, the control terminals of the fifth switch units are connected to a fourth scanning signal line, the control terminals of the third switch unit and the fourth switch unit in the first sub-pixel circuit are both connected to a first scanning signal line, and the control terminals of the third switch unit and the fourth switch unit in the second sub-pixel circuit are both connected to a second scanning signal line.

2. The pixel circuit according to claim 1, wherein two switch units whose control terminals are connected to the same scanning signal line are switches of the same channel type, so that the turn-on or turn-off states of the two switch units connected to the same scanning signal line are identical.

3. The pixel circuit according to claim 1, wherein each of the switch units and each of the driving units are thin film transistors, the control terminal of each switch unit is a gate of the thin film transistor, the first terminal of each switch unit is a source of the thin film transistor, and the second terminal of each switch unit is a drain of the thin film transistor; the control terminal of each driving unit is a gate of the thin film transistor, the input of each driving unit is a source of the thin film transistor, and the output of each driving unit is a drain of the thin film transistor.

4. The pixel circuit according to claim 3, wherein transistors corresponding to the driving units and the switch units are transistors whose source and drain are interchangeable, or the first terminal of each switch unit is a drain of the transistor and the second terminal thereof is a source of the transistor, and the input of each driving unit is a drain of the transistor and the output thereof is a source of the transistor.

5. The pixel circuit according to claim 3, wherein each of the thin film transistors is of P-channel type.

6. The pixel circuit according to claim 1 wherein the energy storage unit is a capacitor.

7. The pixel circuit according to claim 1 wherein the electroluminescent element is an organic light emitting diode.

8. A display apparatus comprising the pixel circuit according to claim 1.

9. The display apparatus according to claim 8, wherein the two sub-pixel circuits of the pixel circuit are positioned within two adjacent pixels respectively.

10. The display apparatus according to claim 9, wherein the two adjacent pixels are positioned on both sides of the data voltage line respectively.

11. The display apparatus according to claim 9, wherein the two adjacent pixels are positioned on the same side of the data voltage line.

12. The pixel circuit according to claim 2, wherein each of the switch units and each of the driving units are thin film transistors, the control terminal of each switch unit is a gate of the thin film transistor, the first terminal of each switch unit is a source of the thin film transistor, and the second terminal of each switch unit is a drain of the thin film transistor; the control terminal of each driving unit is a gate of the thin film transistor, the input of each driving unit is a source of the thin film transistor, and the output of each driving unit is a drain of the thin film transistor.

13. The pixel circuit according to claim 12, wherein transistors corresponding to the driving units and the switch units are transistors whose source and drain are interchangeable, or the first terminal of each switch unit is a drain of the transistor and the second terminal thereof is a source of the transistor, and the input of each driving unit is a drain of the transistor and the output thereof is a source of the transistor.

14. The pixel circuit according to claim 12, wherein each of the thin film transistors is of P-channel type.

15. The display apparatus according to claim 8, wherein two switch units whose control terminals are connected to the same scanning signal line are switches of the same channel type, so that the turn-on or turn-off states of the two switch units connected to the same scanning signal line are identical.

16. The display apparatus according to claim 8, wherein each of the switch units and each of the driving units are thin film transistors, the control terminal of each switch unit is a gate of the thin film transistor, the first terminal of each switch unit is a source of the thin film transistor, and the second terminal of each switch unit is a drain of the thin film transistor; the control terminal of each driving unit is a gate of the thin film transistor, the input of each driving unit is a source of the thin film transistor, and the output of each driving unit is a drain of the thin film transistor.

17. The display apparatus according to claim 16, wherein transistors corresponding to the driving units and the switch units are transistors whose source and drain are interchangeable, or the first terminal of each switch unit is a drain of the transistor and the second terminal thereof is a source of the transistor, and the input of each driving unit is a drain of the transistor and the output thereof is a source of the transistor.

18. The display apparatus according to claim 16, wherein each of the thin film transistors is of P-channel type.

19. The display apparatus according to claim 8, wherein the energy storage unit is a capacitor.

20. The display apparatus according to claim 8, wherein the electroluminescent element is an organic light emitting diode.
